(19) United States
(12) Patent Application Publication
(10) Pub. No.: US 2018/0117847 A1
(43) Pub. Date: May 3, 2018

(54) METHOD FOR FORMING THREE-DIMENSIONAL OBJECT, AND THREE-DIMENSIONAL PRINTER

(71) Applicant: MIMAKI ENGINEERING CO., LTD., Nagano (JP)

(72) Inventor: Hiroyoshi OHI, Nagano (JP)

(21) Appl. No.: 15/565,577

(22) PCT Filed: Apr. 12, 2016
(86) PCT No.: PCT/JP2016/061785

§ 371 Date: Oct. 10, 2017

(30) Foreign Application Priority Data
Apr. 13, 2015 (JP) 2015-081991

(51) Int. Cl. B29C 64/393; B29C 64/112; B33Y 10/00; B33Y 30/00; B33Y 50/02

(52) U.S. Cl. CPC B29C 64/393; B29C 64/112; B33Y 50/02; B33Y 30/00; B33Y 10/00

(57) ABSTRACT

[Object] It is an object to provide a method for forming a three-dimensional object and a three-dimensional printer that inhibit lines from being generated on a surface of a three-dimensional object.

[Means of Realizing the Object] In a method for forming a three-dimensional object, an ink-jet printer forms a three-dimensional object based on three-dimensional data including shape data for specifying a shape of the three-dimensional object and surface image data including a plurality of pixels and representing a surface image of the three-dimensional object. The method for forming a three-dimensional object includes a surface image processing step (step ST2), a slice data calculating step (step ST4), and a unit layer forming step (step ST6). The surface image processing step (step ST2) includes performing image processing to set the color of ink extruded for each pixel. The slice data calculating step (step ST4) includes dividing the three-dimensional data into a plurality of layers and calculating the cross-sectional slice data. The unit layer forming step (step ST6) includes forming each layer based on the cross-sectional slice data.

### TECHNICAL FIELD

The present invention relates to a method for forming a three-dimensional object and to a three-dimensional printer.

### BACKGROUND ART

A method for forming a three-dimensional object, and a three-dimensional printer that form a three-dimensional object by extruding build material such as inks and depositing layers of the build material have been known. For example, in a method for forming a three-dimensional object, and a three-dimensional printer disclosed in patent document 1 described below, shape data for specifying a shape of the three-dimensional object and surface image data for indicating images of surfaces of the three-dimensional object constitute three-dimensional data, which is divided into a plurality of layers.

The method for forming a three-dimensional object and the three-dimensional printer perform half-toning (error diffusion, FM screening, AM screening) on the surface image data of each layer and specify the color of pixels of the surface image data of each layer.

The method for forming a three-dimensional object and the three-dimensional printer form a three-dimensional object in accordance with the three-dimensional data by extruding build material of the specified color from extruders in order from the lowermost layer and curing and depositing the extruded build material.

Such a three-dimensional printer includes ink-jet extruders for individual colors to extrude the build material. The build material is, for example, yellow, magenta, cyan, black, and clear ink.

A conventional method for forming a three-dimensional object will now be described with reference to FIGS. 13 and 14. FIG. 13 is an exemplary flowchart of the conventional method for forming a three-dimensional object. FIG. 14 schematically illustrates an exemplary conventional method for forming a three-dimensional object.

The conventional method for forming a three-dimensional object forms a three-dimensional object using an ink-jet printer. The ink-jet printer includes a carriage, a carriage driver, a platform driver, a controller, and an input device. The carriage includes ink-jet extruders for individual colors. The carriage driver moves the carriage in a main scanning direction. The platform driver moves the platform on which build material is deposited in a sub-scanning direction and a vertical direction. The controller controls these operations. The input device reads the three-dimensional data of the three-dimensional object W.

In the conventional method for forming a three-dimensional object, as illustrated in FIG. 13, first, the three-dimensional data of the three-dimensional object W is read using software in the input device (step ST101). The three-dimensional data includes the shape data for specifying the shape of the three-dimensional object W and the surface image data representing the surface image of the three-dimensional object W.

Subsequently, the input device calculates, based on the shape data of the three-dimensional data and the size of an ink droplet of the ink extruded from each extruder, the total number N of the layers L generated by dividing the three-dimensional data of the three-dimensional object W in a Z axis illustrated in FIGS. 14(a) and 14(b) (step ST102).

The input device executes step ST103 in which the three-dimensional data of the three-dimensional object W is divided into a plurality of layers L in the side view of the three-dimensional object W, and cross-sectional slice data CSD illustrated in FIG. 14(a) of the divided layers L is calculated. For example, in the case of step ST103 to step ST106 performed for the first time, the input device calculates the cross-sectional slice data CSD of the lowermost layer L.

Next, in the plan view of the three-dimensional object W, the input device divides the cross-sectional slice data CSD obtained at step ST103 into a plurality of ink droplet unit pixels UPX in accordance with the hitting area of the ink droplet of the ink extruded from the ink-jet printer.

The input device performs half-toning (such as dithering, error diffusion, FM screening, and AM screening) for setting the color of the ink extruded from the ink-jet printer for each ink droplet unit pixel UPX (step ST104).

Next, the input device converts the cross-sectional slice data CSD of the layers L that have been subjected to step ST104 to a printer command, and transmits the printer command to the controller.

The controller performs a unit layer forming step (step ST105) that allows the ink-jet printer 1 to form each layer L by, for example, generating a print pattern based on the cross-sectional slice data CSD of each layer L that has been subjected to step ST104 and received from the input device and moving the extruders relative to the main scanning direction in accordance with the generated print pattern.

The ink-jet printer 1 forms a desired three-dimensional object by repeating the unit layer forming step (N times at the maximum).

When the unit layer forming step of the n-th time ends, the input device adds one to n (n←n+1, step ST106).

The input device determines whether n has exceeded N (n>N, step ST107).

If it is determined that n has not exceeded N (step ST107: No), the input device returns to step ST103 and calculates the next cross-sectional slice data CSD, and the cross-sectional slice data CSD is subjected to step ST104.

### RELATED ART DOCUMENTS

### Patent Documents

Patent document 1: Japanese Unexamined Patent Application Publication No. 2001-18297

### DISCLOSURE OF THE INVENTION

### Problems to be Solved by the Invention

In the three-dimensional object formed with the aforementioned three-dimensional printer of patent document 1, half-toning is performed on all the layers in the same manner after the three-dimensional data is divided into the plurality of layers.

In this case, in the section of the solid color surfaces of the three-dimensional object, lines may appear on the surfaces that are formed by the plurality of layers and approximately parallel to the deposition direction (for example, the side surfaces of the rectangular solid) due to the same color or the same ink being built continuously in the deposition direction.

More specifically, in the conventional method for forming a three-dimensional object, half-toning (step ST104) performed on the ink droplet unit pixels UPX is carried out in the same manner for n times.

Thus, in the conventional method for forming a three-dimensional object, the cross-sectional slice data CSD that has been subjected to half-toning is deposited as in FIG. 14(a), and lines are generated when the same color is built continuously in the deposition direction as in FIG. 14(b). For example, in FIGS. 14(a) and 14(b), the sections having the same solid color are in blank, and the sections in other colors are shaded.

The present invention has been made in view of the above-described circumstances, and it is an object of the present invention to provide a method for forming a three-dimensional object and a three-dimensional printer that inhibit lines from being generated continuously in a deposition direction on a surface of a three-dimensional object.

### Means of Solving the Problems

To solve the above-mentioned problems and to achieve the object, one aspect of the present invention provides a method for forming a three-dimensional object for a three-dimensional printer to form a three-dimensional object based on three-dimensional data including shape data and surface image data. The shape data specifies a shape of the three-dimensional object. The surface image data includes a plurality of pixels and represents a surface image of the three-dimensional object. The method includes a surface image processing step, a slice data calculating step, and a unit layer forming step. The surface image processing step includes performing half-toning of the surface image data and performing image processing to set a color of ink extruded from the three-dimensional printer for each pixel of the surface image data. The slice data calculating step includes dividing the three-dimensional data including the surface image data subjected to the image processing into a plurality of layers and calculating cross-sectional slice data of each of the divided layers. The unit layer forming step includes forming the layers by the three-dimensional printer based on the cross-sectional slice data of each layer. The unit layer forming step is repeated for each layer to form the three-dimensional object.

In the present invention, the surface image data is subjected to half-toning before dividing the three-dimensional data into the layers. After the half-toning, the color of the ink is set for each pixel of the surface image data. In this case, for example, even if the surface is solid yellow with a slightly mixed magenta, the pixels PX to which the magenta ink is extruded are irregularly generated. Thus, the present invention inhibits lines, which might otherwise be generated by building the same color or the same ink continuously in the deposition direction, from being generated on the solid color surfaces of the three-dimensional object approximately parallel to the deposition direction.

The present invention divides the three-dimensional data into the plurality of layers after performing the image processing to set the color of the ink of each pixel of the surface image data. Thus, the present invention improves the image quality of the surface of the three-dimensional object to a level equivalent to the image quality of the original surface image data and approximates the image quality of the surface of the finished three-dimensional object to the image quality of the surface image data of the three-dimensional data.

The above-described method for forming a three-dimensional object may include a developing step of developing the surface image data to two-dimensional data. The surface image processing step may include performing the image processing of the surface image data that has been developed to the two-dimensional data.

In the present invention, even the surface image data of a case in which the shape data includes a curved surface is developed to two-dimensional data. Thus, image processing for setting the color of the ink of each pixel of the surface image data is easily and reliably performed before dividing into the layers L.

In the above-described method for forming a three-dimensional object, the slice data calculating step may include calculating the cross-sectional slice data including a height corresponding to a size of an ink droplet of the ink extruded from the three-dimensional printer.

In the present invention, when the three-dimensional data is divided into the layers, each layer has a thickness corresponding to the height of the ink droplet.

In the present invention, the three-dimensional data is desirably divided into layers having a thickness corresponding to the height of one ink droplet. Thus, in the present invention, since the thickness of each layer corresponds to the height of the ink droplet, a layer having a desired thickness is reliably formed with the ink.

In the above-described method for forming a three-dimensional object, the slice data calculating step may include dividing each cross-sectional slice data to a plurality of ink droplet unit pixels corresponding to the size of the ink droplet. The method may include, after the slice data calculating step, a slice data processing step of setting the color of the ink extruded from the three-dimensional printer for each ink droplet unit pixel.

In the present invention, the cross-sectional slice data, which is obtained by dividing the three-dimensional data into the layers, is divided into the ink droplet unit pixels each corresponding to the hitting area of the ink droplet in plan view.

In the present invention, the cross-sectional slice data is desirably divided into the ink droplet unit pixels each corresponding to the hitting area of one ink droplet. Thus, in the present invention, since each ink droplet unit pixel corresponds to the hitting area of the ink droplet, a layer having a uniform thickness is reliably formed with the ink.

In the above-described method for forming a three-dimensional object, the slice data processing step may include performing half-toning of the plurality of ink droplet unit pixels of the cross-sectional slice data to set the color of the ink extruded from the three-dimensional printer for each ink droplet unit pixel.

In the present invention, the color of each ink droplet unit pixel of the cross-sectional slice data is set by half-toning. Additionally, in the present invention, even if an ink droplet unit pixel of the cross-sectional slice data is generated to overlap the pixels of the surface image data that have different colors so that the cross-sectional slice data includes a plurality of pixels of the surface image data in the deposition direction of the layers, the color of each ink droplet unit pixel is reliably set, and the color of the ink for forming each layer is set based on the data subjected to half-toning.

Another aspect of the present invention provides a three-dimensional printer for forming a three-dimensional object based on three-dimensional data including shape data and surface image data. The shape data specifies a shape of the three-dimensional object. The surface image data includes a plurality of pixels and represents a surface image of the three-dimensional object. The three-dimensional printer includes an extruder, a relative mover, and a controller. The extruder extrudes ink for forming the three-dimensional object on a work surface. The relative mover causes the extruder to move relative to the work surface. The controller controls operation of the extruder and the relative mover. The controller performs a surface image processing step and a slice data calculating step. The surface image processing step includes performing half-toning of the surface image data and performing image processing to set a color of the ink extruded from the extruder for each pixel of the surface image data. The slice data calculating step includes dividing the three-dimensional data including the surface image data subjected to the image processing into a plurality of layers and calculating cross-sectional slice data of each of the divided layers. After the surface image processing step and the slice data calculating step, a unit layer forming step is repeated that includes extruding ink from the extruder to form each layer based on the cross-sectional slice data of each layer.

In the present invention, the color of the ink of each pixel of the surface image data is set before the three-dimensional data is divided into the layers. Thus, for example, even if the surface is solid yellow with a slightly mixed magenta, the pixels to which the magenta ink is extruded are irregularly generated. Thus, the present invention inhibits magenta lines from being generated on the solid yellow surface of the three-dimensional object.

### Effects of the Invention

The method for forming a three-dimensional object and the three-dimensional printer of the present invention are advantageous in inhibiting lines from being generated on the surface of the three-dimensional object in the deposition direction.

### BRIEF DESCRIPTION OF THE DRAWINGS

FIG. 1 is a diagram illustrating a schematic configuration of an ink-jet printer according to an embodiment.

FIG. 2 is an exemplary flowchart illustrating a method for forming a three-dimensional object according to an embodiment.

FIG. 3 is a perspective view of an exemplary three-dimensional object formed by the ink-jet printer illustrated in FIG. 1.

FIG. 4 is a diagram illustrating three-dimensional data of the three-dimensional object illustrated in FIG. 3.

FIG. 5 is a diagram illustrating part of the surface image data of the three-dimensional data illustrated in FIG. 4 after being subjected to half-toning.

FIG. 6 is a diagram illustrating the three-dimensional data including the surface image data after the half-toning illustrated in FIG. 5.

FIG. 7 is a diagram illustrating cross-sectional slice data obtained by dividing the three-dimensional data illustrated in FIG. 6 into layers.

FIG. 8 is a diagram illustrating the cross-sectional slice data of FIG. 7 after being subjected to half-toning.

FIG. 9 is a diagram illustrating how the layers are deposited based on the cross-sectional slice data illustrated in FIG. 8.

FIG. 10 is a diagram illustrating how the ink droplet unit pixels of the cross-sectional slice data illustrated in FIG. 7 include a plurality of colors.

FIG. 11 is a perspective view of the three-dimensional object obtained by curing the ink extruded layer by layer.

FIG. 12 is an exemplary flowchart of a method for forming a three-dimensional object according to a modification.

FIG. 13 is an exemplary flowchart of a conventional method for forming a three-dimensional object.

FIG. 14 illustrates an exemplary conventional method for forming a three-dimensional object.

### MODE FOR CARRYING OUT THE INVENTION

Hereinafter, a method for forming a three-dimensional object and a three-dimensional printer according to an embodiment of the present invention will be described with reference to the drawings. It will be understood that the embodiment of the present invention is not intended in a limiting sense. The elements and/or components described in the embodiment encompass those elements and/or components readily found by one of ordinary skill in the art as replacements, and encompass substantially identical elements and/or components.

### Embodiment

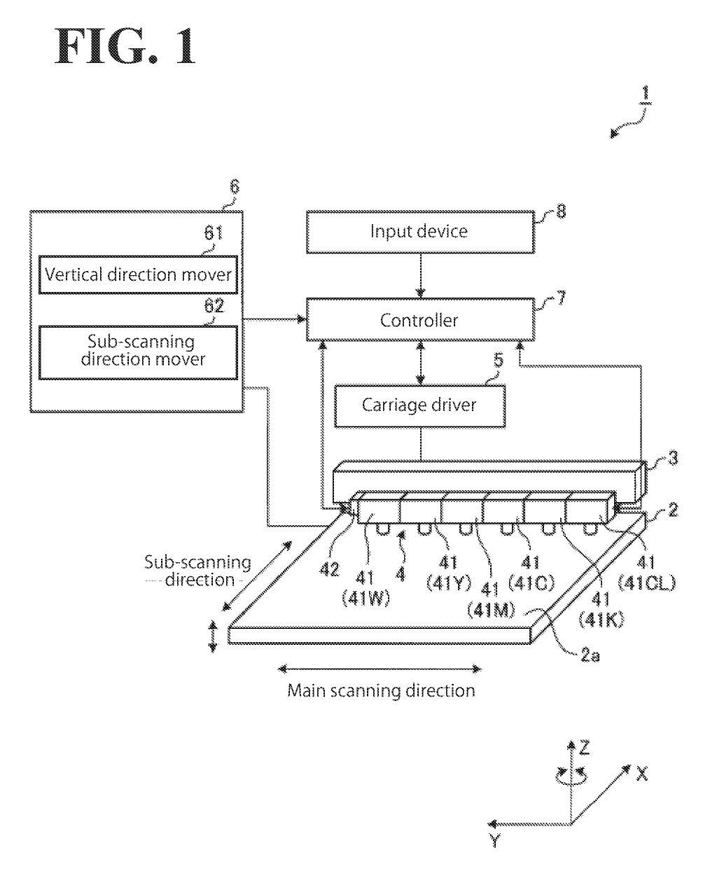

FIG. 1 is a diagram illustrating a schematic configuration of an ink-jet printer according to an embodiment.

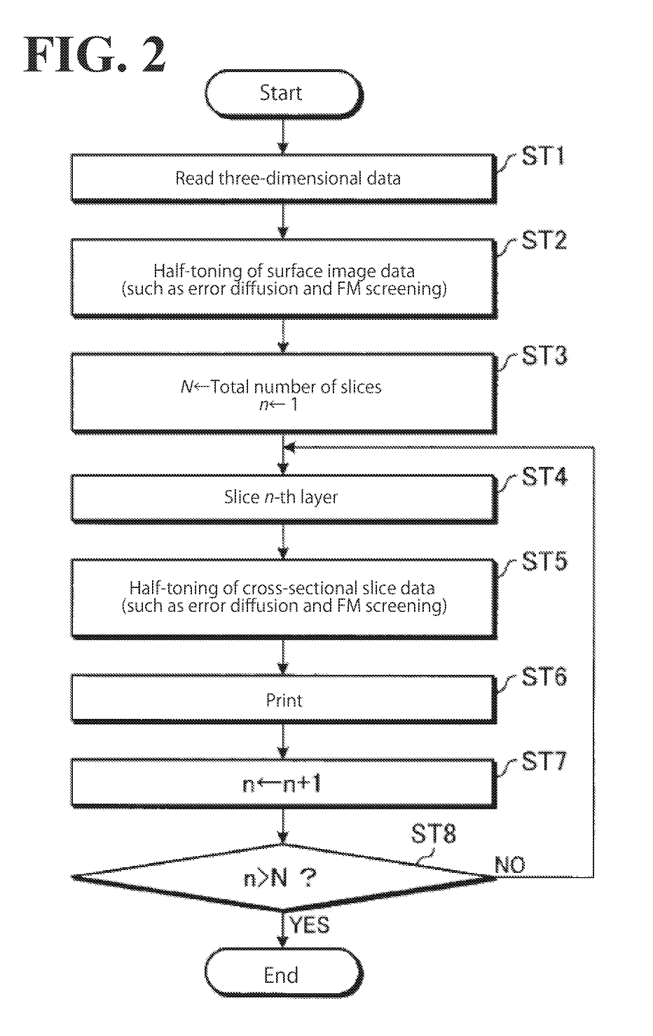

FIG. 2 is an exemplary flowchart illustrating a method for forming a three-dimensional object according to an embodiment.

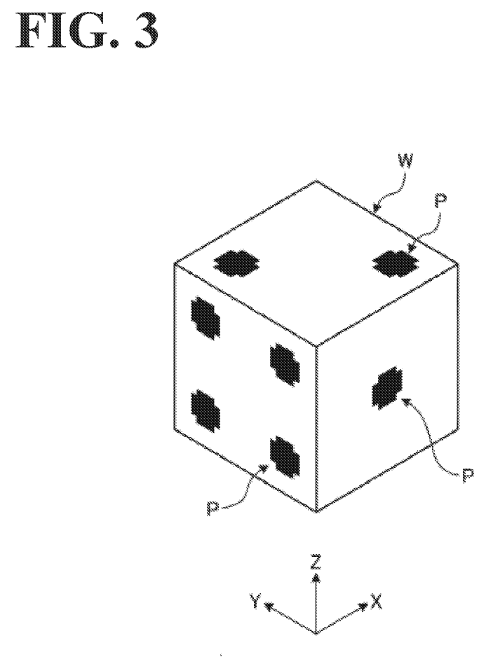

FIG. 3 is a perspective view of an exemplary three-dimensional object formed by the ink-jet printer illustrated in FIG. 1.

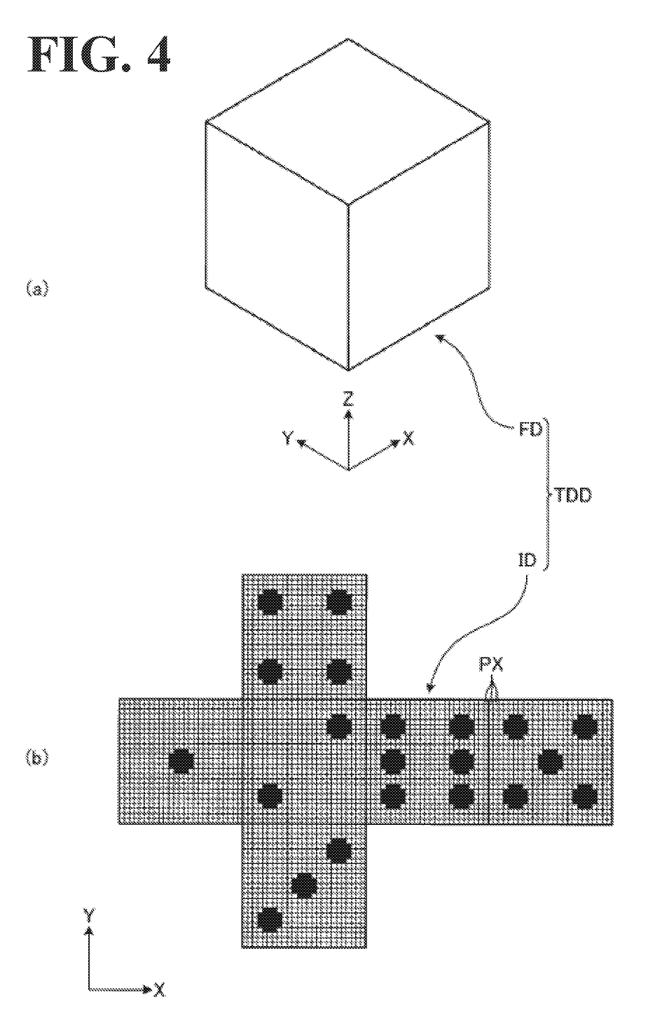

FIG. 4(a) is a diagram illustrating shape data of three-dimensional data of the three-dimensional object illustrated in FIG. 3.

FIG. 4(b) is a diagram illustrating surface image data of the three-dimensional data of the three-dimensional object illustrated in FIG. 3.

A three-dimensional printer according to an embodiment illustrated in FIG. 1 is an ink-jet printer 1. The ink-jet printer 1 is a three-dimensional object forming apparatus that produces a three-dimensional object W (an example is illustrated in FIG. 3) by ink-jet technology.

The ink-jet printer 1 typically divides the three-dimensional object W into a plurality of layers L along a Z direction illustrated in FIG. 11 based on three-dimensional data TDD of the three-dimensional object W (illustrated in FIG. 4). The ink-jet printer 1 then deposits build material (cured ink) in order from a lower layer L based on shape data and surface image data of each layer L of the three-dimensional object W to form the three-dimensional object W in accordance with the three-dimensional data TDD.

One example of the three-dimensional object W illustrated in FIG. 3 is a dice, which is approximately a cube and includes patterns P of 1 to 6 on the surfaces.

In the three-dimensional object W illustrated in FIG. 3, the patterns P, which are formed on the surfaces, are formed into black having a color concentration of 100%, and the sections of the surfaces other than the patterns P are formed of a mixed color of yellow having a color concentration of 100% and magenta having a color concentration of 10%.

However, in the present invention, the shape of the three-dimensional object W is not limited to this shape. In FIG. 3, the patterns P are illustrated in black, and the sections other than the patterns P are blank.

As illustrated in FIG. 1, the ink-jet printer 1 includes a platform 2, a Y bar 3, a carriage 4, a carriage driver 5 (which corresponds to a relative mover), a platform driver 6 (which corresponds to a relative mover), a controller 7, and an input device 8. The upper surface of the platform 2 is a work surface 2a. The Y bar is provided in a main scanning direction.

The work surface 2a of the platform 2 is formed to be flat in the horizontal direction (a direction parallel to both an X axis and a Y axis illustrated in FIG. 1) and is a plane on which the build material, which is ink in this embodiment, is deposited in order from the lower layers L. The platform 2 is, for example, approximately rectangular, but is not limited to this shape.

The Y bar 3 is provided vertically upward of the platform 2 with a predetermined gap. The Y bar 3 is provided straight along the main scanning direction, which is parallel to the horizontal direction (Y axis). The Y bar 3 guides reciprocation of the carriage 4 in the main scanning direction.

The carriage 4 is held by the Y bar 3 and is capable of reciprocating in the main scanning direction along the Y bar 3. The carriage 4 is controlled to move in the main scanning direction.

The carriage 4 includes a plurality of extruders 41 and an ultraviolet emitter 42. The extruders 41 and the ultraviolet emitter 42 are provided on the surface of the carriage 4 that opposes the platform 2 in the vertical direction via, for example, a non-illustrated holder.

The extruders 41 extrude the build material for forming the three-dimensional object W onto the work surface 2a. The build material is ink in this embodiment.

The extruders 41 of the embodiment are capable of extruding ink onto the work surface 2a and are capable of being moved relative to the work surface 2a by the carriage driver 5. The degree of cure of the ink changes by exposure to light.

The extruders 41 are capable of reciprocating along the main scanning direction in accordance with the movement of the carriage 4 in the main scanning direction. The extruders 41 are coupled to an ink tank via, for example, various ink passages, regulators, and pumps. The extruders 41 are provided depending on the types of colors of the ink that can be simultaneously printed.

In the present embodiment, an extruder 41Y for extruding yellow (Y: Yellow) ink, an extruder 41M for extruding magenta (M: Magenta) ink, an extruder 41C for extruding cyan (C: Cyan) ink, an extruder 41K for extruding black (K: Black) ink, an extruder 41CL for extruding clear (CL: Clear) ink, and an extruder 41W for extruding white (W: White) ink are provided sequentially along the main scanning direction.

The extruders 41Y. 41M, 41C, 41K. 41CL, and 41W are ink-jet heads that are capable of extruding ink in the ink tank toward the work surface 2a by ink-jet technology.

The ink in which the degree of cure is changed by exposure to light may be, for example, ultraviolet (UV) curable ink that cures by exposure to ultraviolet light. The UV curable ink is desirably, for example, readily water soluble, readily alcohol soluble, or heat soluble after being cured.

The extruders 41Y, 41M, 41C, 41K, 41CL, and 41W are electrically coupled to the controller 7 and are drivingly controlled by the controller 7.

The extruders 41Y. 41M, 41C. 41K. 41CL, and 41W are arranged in a direction of the Y axis. As described above, the ink-jet printer 1 includes the extruders 41Y, 41M, 41C, 41K. 41CL, and 41W to extrude ink of at least three primary colors for forming the three-dimensional object W.

The ultraviolet emitter 42 applies external stimulation on the ink extruded onto the work surface 2a The ultraviolet emitter 42 is configured to be capable of emitting ultraviolet light (UV) onto the ink supplied to the work surface 2a and exposes the ink to light by emitting the ultraviolet light onto the ink extruded on the work surface 2a.

The ultraviolet emitter 42 includes, for example, an LED module that is capable of emitting ultraviolet light. The ultraviolet emitter 42 is provided on the carriage 4 and is capable of reciprocating in the main scanning direction in accordance with the movement of the carriage 4 in the main scanning direction. The ultraviolet emitter 42 is electrically coupled to the controller 7 and is drivingly controlled by the controller 7.

The carriage driver 5 is a driving device that reciprocates the carriage 4, that is, the extruders 41Y, 41M, 41C, 41K, 41CL, and 41W and the ultraviolet emitter 42 relative to the Y bar 3 in the main scanning direction.

The carriage driver 5 includes, for example, a transmission mechanism, such as a conveyor belt coupled to the carriage 4, and a driving source, such as an electric motor that drives the conveyor belt. The carriage driver 5 converts the power generated by the driving source to the power that moves the carriage 4 in the main scanning direction via the transmission mechanism and reciprocates the carriage 4 in the main scanning direction. The carriage driver 5 is electrically coupled to the controller 7 and is drivingly controlled by the controller 7.

The carriage driver 5 and the platform driver 6 move the extruders 41Y. 41M, 41C, 41K, 41CL, and 41W and the work surface 2a relative to each other.

As illustrated in FIG. 1, the platform driver 6 includes a vertical direction mover 61 and a sub-scanning direction mover 62.

The vertical direction mover 61 moves the platform 2 up and down in the vertical direction, which is parallel to a Z axis, so that the work surface 2a formed on the platform 2 moves up and down in the vertical direction relative to the extruders 41Y, 41M, 41C, 41K, 41CL, and 41W and the ultraviolet emitter 42.

Thus, the platform driver 6 is capable of moving the work surface 2a in the vertical direction to approach and separate from the extruders 41Y, 41M, 41C. 41K. 41CL, and 41W and the ultraviolet emitter 42. That is, the platform driver 6 is capable of moving the work surface 2a in the vertical direction relative to the extruders 41Y, 41M, 41C, 41K, 41CL, and 41W and the ultraviolet emitter 42.

The sub-scanning direction mover 62 moves the platform 2 in the sub-scanning direction, which is parallel to the X axis orthogonal to the main scanning direction, so that the work surface 2a formed on the platform 2 reciprocates in the sub-scanning direction relative to the extruders 41Y. 41M. 41C, 41K, 41CL, and 41W and the ultraviolet emitter 42.

Thus, the platform driver 6 is capable of reciprocating the work surface 2a in the sub-scanning direction with respect to the extruders 41Y, 41M, 41C, 41K, 41CL, and 41W and the ultraviolet emitter 42. That is, the sub-scanning direction mover 62 is capable of reciprocating the work surface 2a in the sub-scanning direction relative to the extruders 41Y, 41M, 41C, 41K. 41CL, and 41W and the ultraviolet emitter 42.

In the embodiment, the sub-scanning direction mover 62 moves the platform 2 in the sub-scanning direction. However, the present invention is not limited to this configuration. Instead, the extruders 41Y. 41M, 41C, 41K. 41CL, and 41W and the ultraviolet emitter 42 may be moved in the sub-scanning direction together with the Y bar 3.

The controller 7 controls the operation of the components of the ink-jet printer 1 including the extruders 41Y, 41M, 41C, 41K, 41CL, and 41W, the ultraviolet emitter 42, the carriage driver 5, and the platform driver 6.

The controller 7 includes hardware, such as a computer and a memory, and programs for implementing predetermined functions of the hardware. The controller 7 controls the extruders 41Y, 41M, 41C, 41K. 41CL, and 41W to control, for example, the amount of extrusion, the extrusion timing, and the period of extrusion of the ink of the extruders 41Y, 41M, 41C, 41K, 41CL, and 41W.

The controller 7 controls the ultraviolet emitter 42 to control, for example, the intensity, the exposure timing, and the period of exposure of the emitted ultraviolet light. The controller 7 controls the carriage driver 5 to control the relative movement of the carriage 4 in the main scanning direction.

The controller 7 controls the platform driver 6 to control the relative movement of the platform 2 in the vertical direction and the sub-scanning direction.

The input device 8 is coupled to the controller 7 and is used to input the three-dimensional data TDD on the shape of the three-dimensional object W. The input device 8 includes, for example, a personal computer (PC) coupled to the controller 7 via cable or wirelessly and various terminals.

Next, the method according to the embodiment for forming a three-dimensional object executed by the above-described ink-jet printer 1 will be described with reference to the flowchart of FIG. 2.

The method for forming a three-dimensional object illustrated in FIG. 2 is executed by the controller 7 and the input device 8 of the ink-jet printer 1. In the description of FIG. 2, FIGS. 4 to 11 will also be referenced. FIGS. 4 to 11 are cross-sectional views and perspective views that schematically describe the method according to the embodiment for forming a three-dimensional object.

The method according to the embodiment for forming a three-dimensional object is a method for producing the three-dimensional object W and is performed by the controller 7 of the ink-jet printer 1 by drivingly controlling the components of the ink-jet printer 1.

In the method for forming a three-dimensional object, first, the software of the input device 8 reads the three-dimensional data TDD of the three-dimensional object W (step ST1).

In the embodiment, the three-dimensional data TDD includes shape data FD illustrated in FIG. 4(a) and surface image data ID illustrated in FIG. 4(b).

The shape data FD is the data for specifying the shape of the three-dimensional object W and includes data indicating the coordinates of the outline surface of the three-dimensional object W on the X axis, the Y axis, and the Z axis, that is, three-dimensional coordinate data.

The surface image data ID is data representing the image of the surface of the three-dimensional object W and includes a plurality of pixels PX constituting the image of the surface of the three-dimensional object W.

The surface image data ID includes data representing the coordinates of the pixels PX constituting the image of the surface of the three-dimensional object W on the X axis and Y axis, that is, two-dimensional coordinate data and color data representing the color of the pixels PX. In the three-dimensional data TDD, the coordinates of the shape data FD and the coordinates of the surface image data ID are correlated.

As described above, in the embodiment, the surface image data ID of the three-dimensional data TDD represents the image of the surface of the three-dimensional object W in full color. In the surface image data ID of the embodiment, the color data of the pixels PX of the sections representing the patterns P is black having a color concentration of 100% (black sections in FIG. 4(b)), and the color data of the pixels PX representing the sections other than the patterns P is a mixed color of yellow having a color concentration of 100% and magenta having a color concentration of 10% (blank sections in FIG. 4(b)).

Next, the input device 8 executes a surface image processing step (step ST2) in which the surface image data ID of the entire three-dimensional object W is subjected to half-toning, and image processing is performed to set the color of ink to be extruded from the ink-jet printer 1 for each pixel PX of the surface image data ID.

In the surface image processing step (step ST2), the input device 8 performs at least one of dithering, error diffusion, FM screening, and AM screening, which are known half-toning processes, on the plurality of pixels PX constituting the surface image data ID of the entire three-dimensional object W.

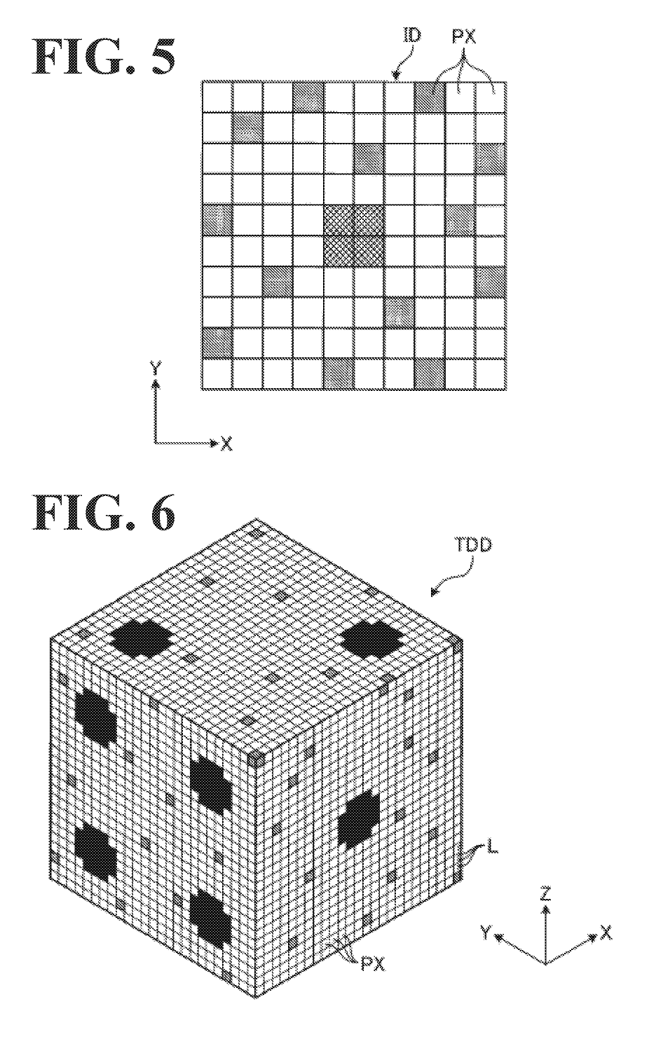

As illustrated in FIG. 5, the color of ink extruded by the ink-jet printer 1, that is, the extruder 41Y, 41M, 41C, 41K, 41CL, or 41W for forming each pixel PX is set for each of the pixels PX constituting the surface image data ID subjected to the above-described half-toning.

As illustrated in FIG. 5, in the input device 8, the surface image data ID that has been subjected to image processing includes the pixels PX representing the patterns P in black (illustrated in grid patterns) and the pixels PX representing the sections other than the patterns P in yellow (illustrated with blank sections) or in magenta (illustrated with shaded sections).

At this time, the ratio of the number of the pixels PX in yellow to the number of the pixels PX in magenta is approximately 10 to 1, and the pixels PX in magenta exist irregularly in the pixels PX of yellow. In FIG. 5, the pixels PX are exaggerated and only part of the surface image data ID is illustrated.

Subsequent to the surface image processing step (step ST2), the input device 8 calculates the number N of the layers L that divide the three-dimensional data TDD of the three-dimensional object W in the direction of the Z axis based on the shape data FD of the three-dimensional data TDD and the height of the ink droplets of the ink extruded from the extruders 41Y, 41M, 41C, 41K, 41CL, and 41W (step ST3).

More specifically, the input device 8 calculates the height of the three-dimensional object W in the direction of the Z axis based on the shape data FD and calculates the number N of the layers L by dividing the calculated height by the height of the ink droplet of the ink.

In the present embodiment, the height of the three-dimensional object W in the direction of Z axis is divided by the thickness of each layer L formed by one ink droplet to calculate the number N of the layers L. In the process performed for the first time, one is substituted for “n”. (n←1, step ST3)

Subsequently, as illustrated in FIG. 6, the input device 8 adheres the surface image data ID that has been subjected to image processing through the surface image processing step (step ST2) to the surface of the shape data FD and calculates the three-dimensional data TDD including the surface image data ID.

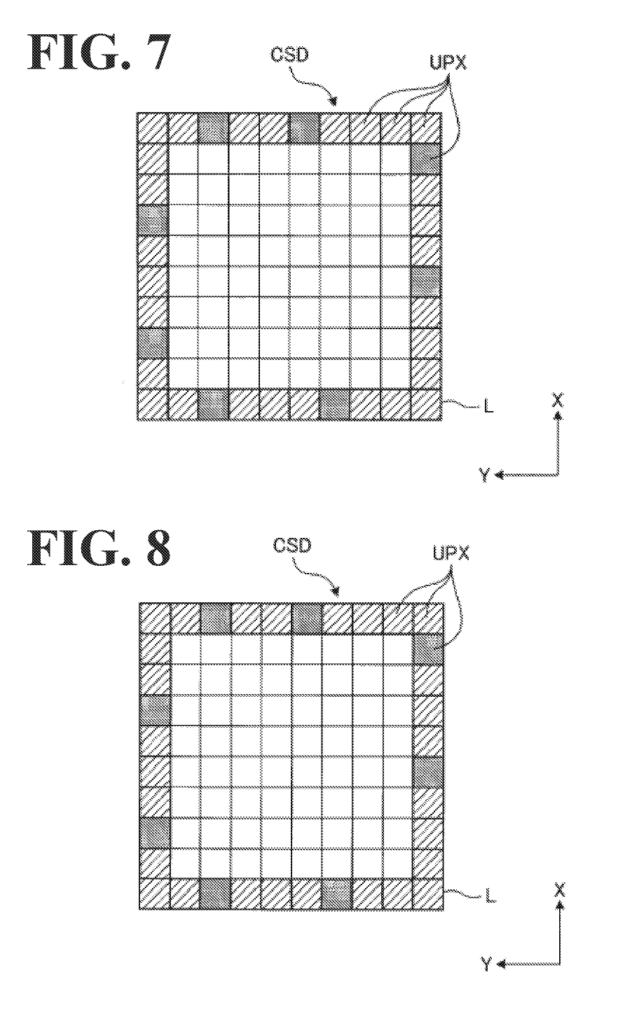

As illustrated in FIG. 7, the input device 8 divides the three-dimensional data TDD into the plurality of layers L and executes a slice data calculating step (step ST4) to calculate cross-sectional slice data CSD of each of the divided layers L.

For example, in a case of step ST4 to step ST7 performed for the first time, calculation of the lowermost layer L is performed.

In the slice data calculating step (step ST4), the input device 8 divides the three-dimensional data TDD, which includes the surface image data ID subjected to the image processing by the surface image processing step (step ST2) and the shape data FD, into the plurality of layers L to calculate the cross-sectional slice data CSD having a thickness corresponding to the height of the ink droplet of the ink extruded from the ink-jet printer 1.

In the present embodiment, the three-dimensional data TDD, which includes the surface image data ID subjected to the image processing by the surface image processing step (step ST2) and the shape data FD, is divided into the layers L having a thickness that can be formed by one ink droplet of the ink extruded from the ink-jet printer 1 to calculate the cross-sectional slice data CSD.

For example, in a case of step ST4 to step ST7 performed for the first time, calculation of the lowermost layer L is performed.

As illustrated in FIG. 7, in the slice data calculating step (step ST4), the input device 8 divides the cross-sectional slice data CSD into a plurality of ink droplet unit pixels UPX as viewed from the X-Y plane in accordance with the hitting area of the ink droplet of the ink extruded from the ink-jet printer 1.

In the present embodiment, each cross-sectional slice data CSD is divided into the ink droplet unit pixels UPX each corresponding to the hitting area that can be formed by one ink droplet of the ink extruded from the ink-jet printer 1.

Thus, the thickness of the cross-sectional slice data CSD and the area of each ink droplet unit pixel UPX are often different from the size of the pixel PX of the surface image data ID of the three-dimensional data TDD.

In the present embodiment, the thickness of the cross-sectional slice data CSD and the area of each ink droplet unit pixel UPX are less than the thickness and the area of the pixel PX of the surface image data ID of the three-dimensional data TDD.

In the cross-sectional slice data CSD, the ink droplet unit pixels UPX representing the patterns P are in black, and the ink droplet unit pixels UPX representing the sections other than the patterns P are in yellow or magenta.

At this time, the ratio of the number of the ink droplet unit pixels UPX in yellow to the number of the ink droplet unit pixels UPX in magenta is approximately 10 to 1, and the ink droplet unit pixels UPX in magenta exist irregularly in the ink droplet unit pixels UPX in yellow. In FIGS. 7 to 10, the ink droplet unit pixels UPX of the cross-sectional slice data CSD are exaggerated, and some of the plurality of ink droplet unit pixels UPX that are in solid magenta are shaded, some in solid yellow are diagonally hatched, and some in white are blank.

Next, the input device 8 performs a slice data processing step (step ST5) in which the surface image data ID of the cross-sectional slice data CSD calculated by the slice data calculating step (step ST4) is subjected to half-toning to set the color of the ink extruded from the ink-jet printer 1 for each of the ink droplet unit pixels UPX of the cross-sectional slice data CSD.

In the slice data processing step, the input device 8 performs half-toning on the plurality of ink droplet unit pixels UPX constituting the surface image data ID of the cross-sectional slice data CSD. The half-toning process is at least one of known error diffusion, FM screening, and AM screening.

As illustrated in FIG. 8, the color of the ink extruded from the ink-jet printer 1, that is, the extruders 41Y, 41M, 41C, 41K, and 41CL for forming the ink droplet unit pixels UPX are set for the ink droplet unit pixels UPX constituting the surface image data ID of the cross-sectional slice data CSD that has been subjected to the above-described half-toning.

In the slice data processing step, the input device 8 sets the ink droplet unit pixels UPX other than the ink droplet unit pixels UPX constituting the surface image data ID to be formed with the extruder 41W.

In the cross-sectional slice data CSD that has been subjected to the slice data processing step (step ST5), like the cross-sectional slice data CSD before the slice data processing step (step ST5), the ink droplet unit pixels UPX representing the patterns P are in black, and the ink droplet unit pixels UPX representing the sections other than the patterns P are in yellow or magenta.

At this time, the ratio of the number of the ink droplet unit pixels UPX in yellow to the number of the ink droplet unit pixels UPX in magenta is approximately 10 to 1, and the ink droplet unit pixels UPX in magenta exist irregularly in the ink droplet unit pixels UPX in yellow.

In the present embodiment, as illustrated in FIG. 10(a), since each ink droplet unit pixel UPX in the Z direction is smaller than the pixel PX, some of the ink droplet unit pixels UPX of the cross-sectional slice data CSD after the slice data calculating step (step ST4) may include a plurality of colors.

In this case, when the slice data processing step (step ST5) is performed, the ink droplet unit pixels UPX that had included a plurality of colors before the process are formed with a single color as illustrated in FIG. 10(b).

Subsequently, the input device 8 converts the cross-sectional slice data CSD that has been subjected to the slice data processing step (step ST5) into a printer command and transmits the printer command to the controller 7.

Based on the cross-sectional slice data CSD of the layers L that has been subjected to the slice data processing step (step ST5) received from the input device 8, the controller 7 performs a unit layer forming step (step ST6) that causes the ink-jet printer 1 to form each layer L.

In the unit layer forming step (step ST6), the controller 7 generates a print pattern of the cross-sectional slice data CSD of each layer L and generates the extrusion control amount, the curing control amount, and the control amount of the carriage driver 5 and the platform driver 6 that enable the generated print pattern to be formed.

First, the controller 7 moves the extruders 41Y, 41M, 41C, 41K, 41CL, and 41W and the ultraviolet emitter 42 relative to the work surface 2a of the platform 2 in the main scanning direction according to the generated extrusion pattern. In this manner, the ink is extruded to the work surface 2a, and the extruded ink is exposed to the ultraviolet light.

Subsequently, the platform 2 is moved in the sub-scanning direction. After the platform 2 is moved, the ink is extruded to the work surface 2a from the extruders 41Y, 41M, 41C. 41K. 41CL, and 41W, and the extruded ink is exposed to light by the ultraviolet emitter 42 again.

These operations are repeated to form the layers L.

More specifically, the controller 7 controls the carriage driver 5 and the vertical direction mover 61 to position the carriage 4 at a suitable position with respect to the work surface 2a.

While causing the carriage driver 5 to move the carriage 4 in the main scanning direction, the controller 7 causes the extruders 41Y. 41M, 41C, 41K, 41CL, and 41W to extrude ink at a point in time suitable for forming each layer L generated in the extrusion pattern generation process and causes the ultraviolet emitter 42 to emit ultraviolet light. Thus, the extruded ink hits the work surface 2a or the formed layer L and is cured by the ultraviolet light.

As described above, in the present embodiment, the thickness of the ink droplet unit pixel UPX is less than the pixel PX. Thus, while causing the carriage 4 to move in the main scanning direction once or more, the controller 7 causes the extruders 41Y, 41M, 41C, 41K, 41CL, and 41W to extrude ink and exposes the extruded ink to light to be cured until the ink is built to the thickness equal to the pixel PX.

The controller 7 controls the sub-scanning direction mover 62 to move the platform 2 in the sub-scanning direction by a predetermined distance and then repeats the aforementioned process to form the entire layer L.

Next, when the above-described process performed for the n-th time ends, the input device 8 adds one to n (n←n+1, step ST7). The input device 8 then determines whether n exceeds N (n>N, step ST8).

If it is determined that n has not exceeded N (step ST8: No), the input device 8 returns to the slice data calculating step (step ST4) and calculates the next cross-sectional slice data CSD. The input device 8 then performs half-toning of the cross-sectional slice data CSD (step ST5), converts the cross-sectional slice data CSD to the printer command, and transmits the printer command to the controller 7.

The controller 7 controls the vertical direction mover 61 to lower the work surface 2a by a distance corresponding to one layer L and positions the work surface 2a at a position in the vertical direction suitable for forming the next layer L.

First, the controller 7 generates the extrusion pattern and causes the extruders 41Y, 41M, 41C, 41K, 41CL, and 41W and the ultraviolet emitter 42 to move relative to the work surface 2a of the platform 2 in the main scanning direction in accordance with the generated extrusion pattern. In this manner, the ink is extruded to the work surface 2a, and the extruded ink is exposed to the ultraviolet light.

Subsequently, the platform 2 is relatively moved in the sub-scanning direction, the ink is extruded from the extruders 41Y, 41M, 41C, 41K, 41CL, and 41W onto the work surface 2a, and the extruded ink is exposed to light by the ultraviolet emitter 42.

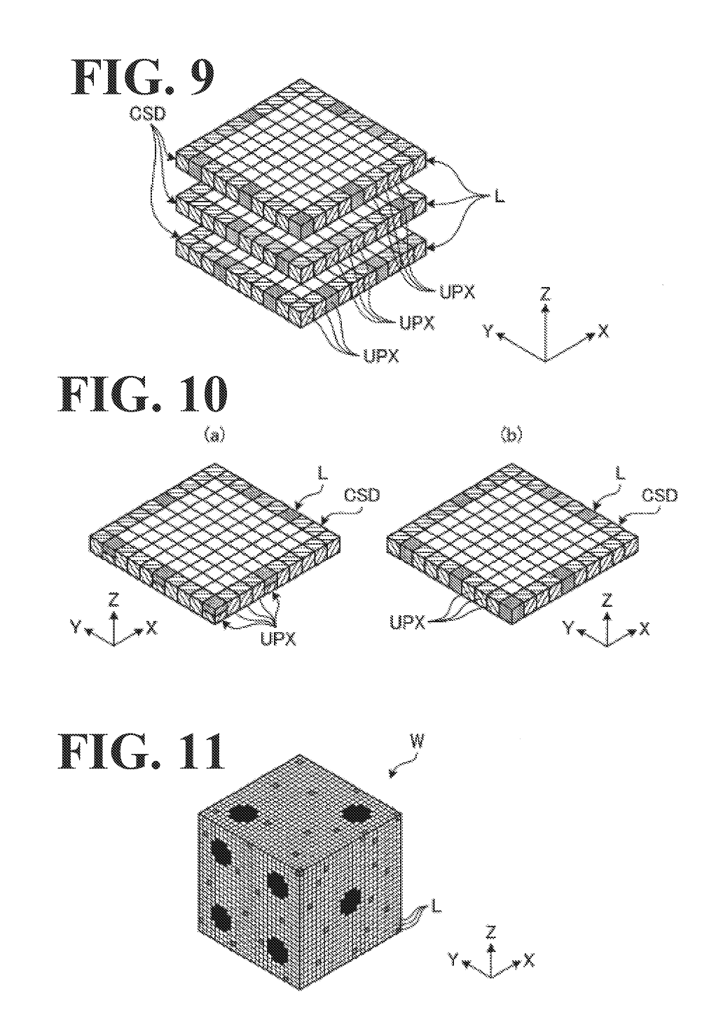

The layers L are formed as illustrated in FIG. 9 by repeating these operations (step ST5).

The controller 7 and the input device 8 form the three-dimensional object W in order from the lower layers L as illustrated in FIG. 11 by repeating the aforementioned unit layer forming step (step ST6) for each layer L. If it is determined that n has exceeded N (n>N) (step ST8: Yes), the input device 8 completes forming the three-dimensional object W, removes the three-dimensional object W from the work surface 2a, and ends the method according to the embodiment for forming a three-dimensional object.

The completed three-dimensional object W is formed into a shape specified by the shape data FD of the three-dimensional data TDD and includes the image specified by the surface image data ID formed on the surface. In the present embodiment, the patterns P are formed in black color, and the sections other than the patterns P are formed in yellow or magenta on the surfaces of the three-dimensional object W.

At this time, the ratio of the area of the yellow section to the area of the magenta section is approximately 10 to 1, and magenta exists irregularly in yellow. In FIG. 11, magenta is illustrated with shaded sections, and yellow is illustrated with blank sections.

The ink-jet printer 1 and the method for forming a three-dimensional object according to the above embodiment execute, before dividing the three-dimensional data TDD of the three-dimensional object W into the layers L, the surface image processing step (step ST2) in which the image processing is performed to set the color of the ink of each pixel PX of the surface image data ID.

Thus, for example, even if the surface is solid yellow with a slightly mixed magenta, the pixels PX to which the magenta ink is extruded are irregularly generated on the surface.

Thus, the ink-jet printer 1 and the method for forming a three-dimensional object inhibit lines, which might otherwise be generated by building the same color or the same ink continuously in the deposition direction, from being generated on the solid color surfaces of the three-dimensional object W where the plurality of layers are deposited continuously to form the surfaces (in FIG. 11, X-Z surface and Y-Z surface).

Additionally, after executing the surface image processing step (step ST2), in which the image processing is performed to set the color of the ink of each pixel PX of the surface image data ID, the ink-jet printer 1 and the method for forming a three-dimensional object execute the slice data calculating step (step ST4), in which the three-dimensional data TDD is divided into the plurality of layers L to calculate the cross-sectional slice data CSD.

Thus, the ink-jet printer 1 and the method for forming a three-dimensional object improve the image quality of the surface of the three-dimensional object W to a level equivalent to the image quality of the original surface image data ID and approximate the image quality of the surface of the finished three-dimensional object W to the image quality of the surface image data ID of the three-dimensional data TDD.

In the ink-jet printer 1 and the method for forming a three-dimensional object, the surface image data ID is a full-color image, and the image processing is performed to set the color of the ink of each pixel PX of the surface image data ID by half-toning in the surface image processing step (step ST2).

Thus, the ink-jet printer 1 and the method for forming a three-dimensional object inhibit vertical stripes from being generated on the solid color surfaces of the three-dimensional object W.

In the side view of the three-dimensional object W, when the ink-jet printer 1 and the method for forming a three-dimensional object divide the three-dimensional data TDD of the three-dimensional object W into the layers L along the Z axis, each layer L has a thickness corresponding to the height of the ink droplet.

In the present embodiment, the ink-jet printer 1 and the method for forming a three-dimensional object divide the three-dimensional data TDD of the three-dimensional object W into the layers L having a thickness corresponding to the height of a single ink droplet 1.

In this case, the ink-jet printer 1 and the method for forming a three-dimensional object reliably form a layer having a desired thickness with the ink since each layer L has a thickness corresponding to the height of the ink droplet.

In the plan view of the three-dimensional object W, the ink-jet printer 1 and the method for forming a three-dimensional object divide the cross-sectional slice data CSD, which is obtained by dividing the three-dimensional data TDD into the layers L, into the ink droplet unit pixels UPX corresponding to the hitting area of the ink droplet.

In the present embodiment, the cross-sectional slice data CSD is divided into the ink droplet unit pixels UPX each corresponding to the hitting area of a single ink droplet 1. The ink-jet printer 1 and the method for forming a three-dimensional object reliably form each layer L uniformly with the ink since each ink droplet unit pixel UPX corresponds to the hitting area of the ink droplet.

The ink-jet printer 1 and the method for forming a three-dimensional object set the color of each ink droplet unit pixel UPX of the cross-sectional slice data CSD by half-toning.

Thus, in the ink-jet printer 1 and the method for forming a three-dimensional object, if an ink droplet unit pixel UPX of the cross-sectional slice data CSD is generated to overlap the pixels PX of the surface image data ID that have different colors so that the ink droplet unit pixel UPX of the cross-sectional slice data CSD includes the colors of the plurality of pixels PX of the surface image data ID in the deposition direction of the layers L, the color of each ink droplet unit pixel UPX is reliably set to a solid color, and the color of the ink for forming each layer L is set based on the data subjected to half-toning.

[Modification]

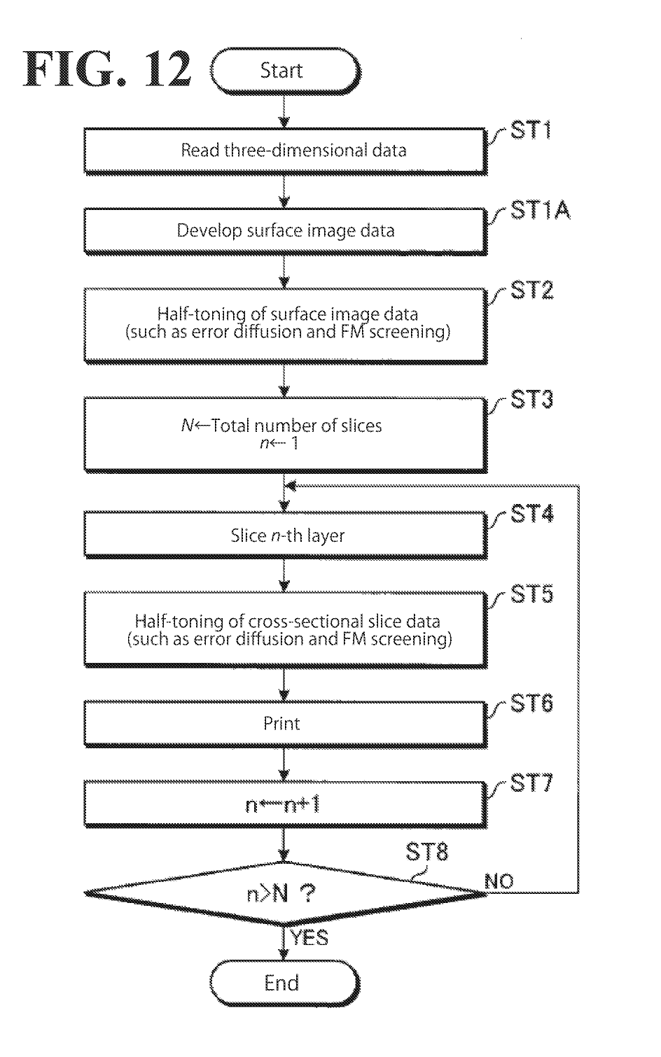

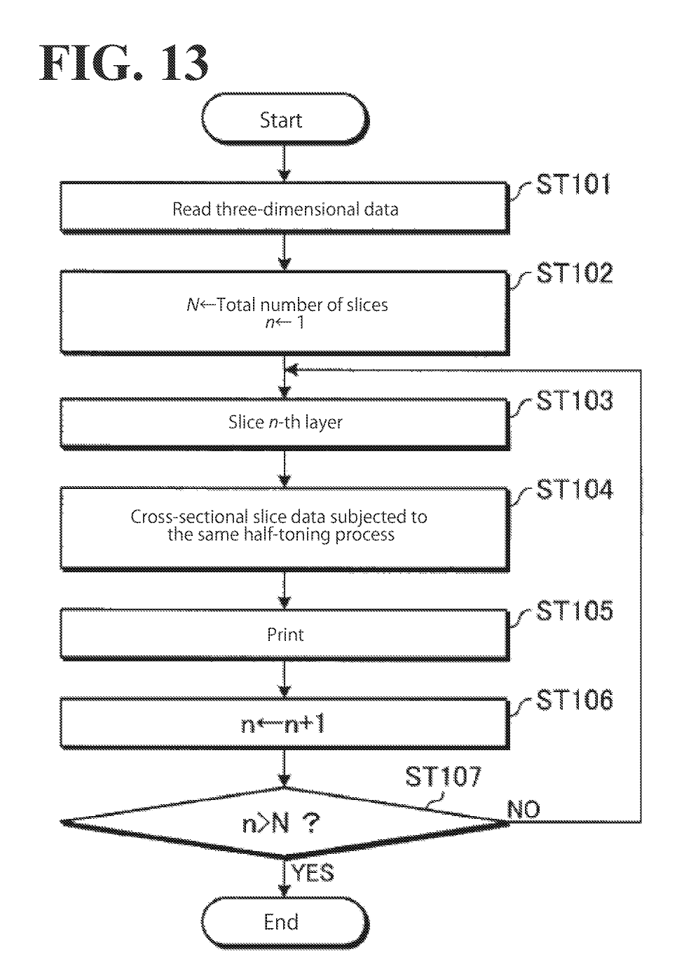

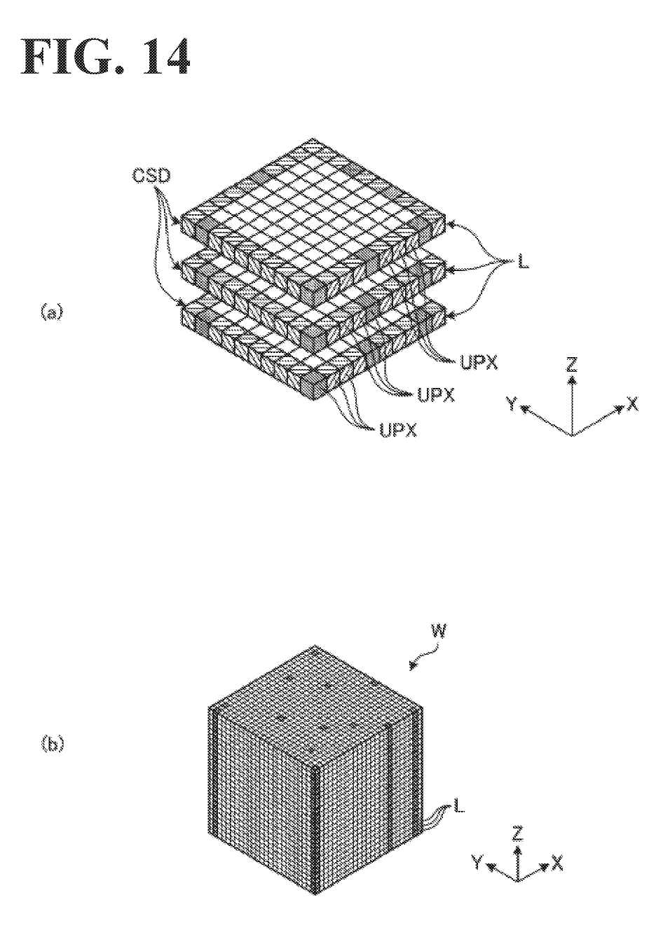

FIG. 12 is an exemplary flowchart of a method for forming a three-dimensional object according to a modification of the embodiment. In FIG. 12, like or the same reference numerals are given to those components that are like or the same as the corresponding components of the above-described embodiment, and detailed explanations are omitted.

The three-dimensional data TDD of the three-dimensional object W read from the input device 8 to the controller 7 of the three-dimensional printer according to the modification of the embodiment, which is the ink-jet printer 1, is configured such that the surface image data ID includes data representing the coordinates of each pixel PX on the surface of the shape data FD on the X axis, the Y axis, and the Z axis, that is, the three-dimensional coordinate data and the color data representing the color of each pixel PX.

After reading the three-dimensional data TDD of the three-dimensional object W from the input device 8 (step ST1), the controller 7 executes a developing step (step ST1A) to develop the three dimensional coordinate data of each pixel PX of the surface image data ID of the three-dimensional data TDD to the two-dimensional coordinate data.

As described above, in the developing step (step ST1A), the three-dimensional surface image data ID is developed to the two-dimensional coordinate data. Subsequently, in the surface image processing step (step ST2), the controller 7 of the ink-jet printer 1 according to the modification performs half-toning of the surface image data ID that has been developed to the two-dimensional coordinate data in the developing step (step ST1A), performs the image processing to set the color of the ink to be extruded for each pixel PX, and executes step ST3 and the following steps in the manner similar to the embodiment.

The ink-jet printer 1 and the method for forming a three-dimensional object according to the modification inhibit lines from being generated on the solid color surface of the three-dimensional object W like in the embodiment.

Additionally, in the ink-jet printer 1 and the method for forming a three-dimensional object according to the modification of the embodiment, even if the surface image data ID includes the shape data that represents a curved surface, the shape data is developed to the two-dimensional coordinate data. Thus, image processing for setting the color of the ink of each pixel PX of the surface image data ID is easily and reliably performed before dividing into the layers L.

The embodiment and the modification of the present invention are described above. However, the present invention is not limited to these configurations. The present invention may be embodied in other various forms without departing from the spirit or scope of the invention and may omit, replace, or change the combination of various components.

### DESCRIPTION OF THE REFERENCE NUMERAL

1 Ink-jet printer (three-dimensional printer)
2a Work surface
41, 41Y, 41M, 41C, 41K. 41CL Extruder
5 Carriage driver (relative mover)
6 Platform driver (relative mover)
7 Controller
TDD Three-dimensional data
FD Shape data
ID Surface image data
PX Pixel
CSD Cross-sectional slice data
UPX Ink droplet unit pixel
ST1A Developing process (step)
ST2 Surface image processing step
ST4 Slice data calculating step
ST5 Slice data processing step
ST6 Unit layer forming step
W Three-dimensional object
L Layer

1. A method for forming a three-dimensional object for a three-dimensional printer to form a three-dimensional object based on three-dimensional data, the three-dimensional data comprising:
shape data for specifying a shape of the three-dimensional object; and
surface image data comprising a plurality of pixels and representing a surface image of the three-dimensional object, the method comprising:
a surface image processing step of performing half-toning of the surface image data and performing image processing to set a color of ink extruded from the three-dimensional printer for each pixel of the surface image data;
a slice data calculating step of dividing the three-dimensional data comprising the surface image data subjected to the image processing into a plurality of layers and calculating cross-sectional slice data of each of the divided layers;
a unit layer forming step of forming the layers by the three-dimensional printer based on the cross-sectional slice data of each layer; and
repeating the unit layer forming step for each layer to form the three-dimensional object.

2. The method for forming a three-dimensional object according to claim 1, further comprising a developing step of developing the surface image data to two-dimensional data,
wherein the surface image processing step comprises performing the image processing of the surface image data that has been developed to the two-dimensional data.

3. The method for forming a three-dimensional object according to claim 1, wherein the slice data calculating step comprises calculating the cross-sectional slice data comprising a height corresponding to a size of an ink droplet of the ink extruded from the three-dimensional printer.

4. The method for forming a three-dimensional object according to claim 3, wherein the slice data calculating step comprises dividing each cross-sectional slice data to a plurality of ink droplet unit pixels corresponding to the size of the ink droplet, wherein the method comprises
after the slice data calculating step, a slice data processing step of setting the color of the ink extruded from the three-dimensional printer for each ink droplet unit pixel.

5. The method for forming a three-dimensional object according to claim 4, wherein the slice data processing step comprises performing half-toning of the plurality of ink droplet unit pixels of the cross-sectional slice data to set the color of the ink extruded from the three-dimensional printer for each ink droplet unit pixel.

6. A three-dimensional printer for forming a three-dimensional object based on three-dimensional data, the three-dimensional data comprising:
shape data for specifying a shape of the three-dimensional object; and
surface image data comprising a plurality of pixels and representing a surface image of the three-dimensional object, the three-dimensional printer comprising:
an extruder configured to extrude ink for forming the three-dimensional object on a work surface;
a relative mover configured to cause the extruder to move relative to the work surface; and
a controller configured to control operation of the extruder and the relative mover, wherein the controller is configured to perform
a surface image processing step of performing half-toning of the surface image data and performing image processing to set a color of the ink extruded from the extruder for each pixel of the surface image data,
a slice data calculating step of dividing the three-dimensional data comprising the surface image data subjected to the image processing into a plurality of layers and calculating cross-sectional slice data of each of the divided layers, and
after the surface image processing step and the slice data calculating step, repeating a unit layer forming step of extruding ink from the extruder to form each layer based on the cross-sectional slice data of each layer.
